(19) United States
(12) Patent Application Publication
(10) Pub. No.: US 2008/0318468 A1
(43) Pub. Date: Dec. 25, 2008

(54) Electrical connector

(75) Inventor: Yu Zhu, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/214,734

(22) Filed: Jun. 19, 2008

(30) Foreign Application Priority Data
Jun. 19, 2007 (CN) 200720038734.4

(51) Int. Cl. H01R 13/73

(52) U.S. Cl. 439/566

(57) ABSTRACT

An electrical connector comprises an elongate dielectric housing a plurality of conductive contacts and a pair of metal post. The dielectric housing comprises a pair of blocks on opposite elongate sides and a mating portion between said pair of blocks. Each said block comprises a planar mounting surface, an opposite upper surface, and through hole perpendicular to said mounting surface. The pair of metal posts are respectively inserted into said through holes in said pair of blocks, each metal post comprises a connecting portion stick out said mounting surface of said block, and a stop section hold on the upper surface of said block. The blocks can be made into a thin board, and the stop section of the post can be made into a thin cap. The total height of the block and post, from the mounting surface, can be made very low to meet the demand of smaller and thinner equipment.

### BACKGROUND OF THE INVENTION

1. Field of the Invention

The present invention is generally related to an electrical connector, and especially, to an electrical connector for mounting on a printed circuit board.

2. Description of Related Art

An electrical connector, such as an electrical connector meeting the Serial ATA (Advanced Technology attachment) specification, is adapted to hard disk. There is a plug connector mounted on a printed circuit board in the hard disk and a receptacle connector mounted on the mother board. The hard disk is electrically connected to the mother board when the plug connector is engaged with the receptacle connector. Since the hard disk generally is heavy and has a big shape, it is easy to producing a heavy force between the engaging connectors, so a retaining device is need to hold the connector on the printed circuit board to prevent the connectors from damage.

Because of the demand of smaller and thinner equipment, it is desirable that connectors be made smaller and thinner while providing the same performance characteristics.

U.S. Pat. No. 7,074,079, issued on Jul. 11, 2006, disclosed a kind of retaining device 120 used on a connector. This retaining device 120 is formed by substantially bending a plate into an L-Shape. Thus the retaining device 120 comprises a horizontal piece 121 and vertical piece 122. The horizontal piece 121 is to be soldered and he vertical piece 122 is to be secured on the connector housing 110. In order to get a enough strength to hold the housing, the vertical piece 122 must be made enough big, but since the vertical piece 122 extending upwardly, it make the connector is difficult to be made totally lower.

Hence, an improved connector is required to overcome the disadvantages of the prior art.

### SUMMARY OF THE INVENTION

Accordingly, an object of the present invention is to provide an electrical connector for mounting on a printed circuit board.

In order to achieve the above-mentioned object, an electrical connector in accordance with the present invention comprises an elongate dielectric housing, a plurality of conductive contacts and a pair of metal post. The dielectric housing comprises a pair of blocks on opposite elongate sides and a mating portion between said pair of blocks. Each said block comprises a planar mounting surface, an opposite upper surface, and through hole perpendicular to said mounting surface. The plurality of conductive contacts are respectively secured in said dielectric housing, a section of each conductive contact extends to said mating portion for contacting with a complementary electrical connector. The pair of metal posts are respectively inserted into said through holes in said pair of blocks, each metal post comprises a connecting portion stick out said mounting surface of said block, and a stop section hold on the upper surface of said block.

In the electrical connector in accordance with the present invention, the blocks can be made into a thin board, and the stop section of the post can be made into a thin cap. The total height of the block and post, from the mounting surface, can be made very low to meet the demand of smaller and thinner equipment.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of an electrical connector of a preferred embodiment of the present invention;

FIG. 2 is a perspective view of the electrical connector as shown in FIG. 1, a metal post is disassembled;

FIG. 3 is a front view of the electrical connector as shown in FIG. 1.

FIG. 4 is another perspective view of the electrical connector as shown in FIG. 1 viewed from another direction.

### DETAILED DESCRIPTION OF THE INVENTION

Reference will now be made in detail to the preferred embodiment of the present invention.

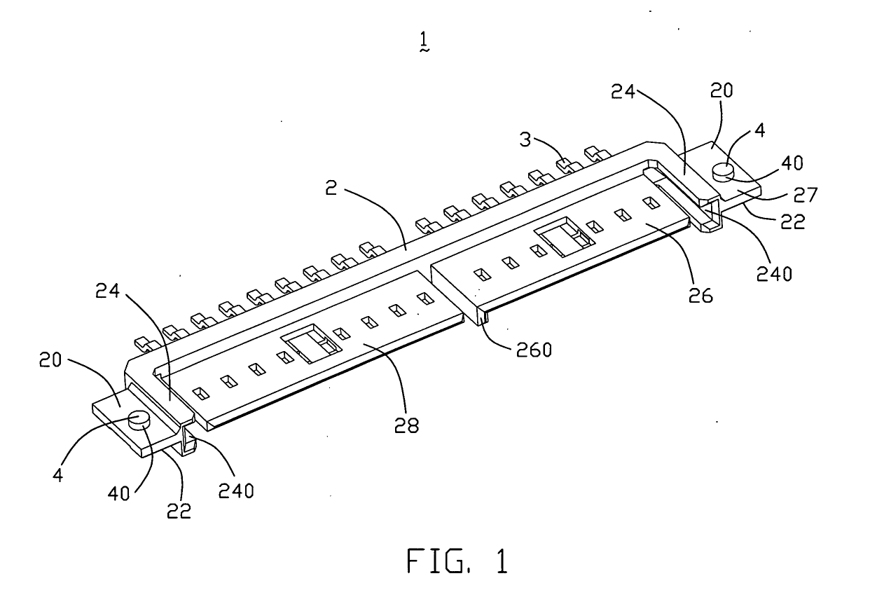

Referring to FIGS. 1-4, an electrical connector 1 adapted for engaging with a complementary electrical connector (not shown) and mounting on a printed circuit board (not shown) to establish electrical connection between the complementary electrical connector (not shown) and the printed circuit board (not shown), comprises an elongate dielectric housing 2, a plurality of conductive contacts 3, and a pair of metal posts 4.

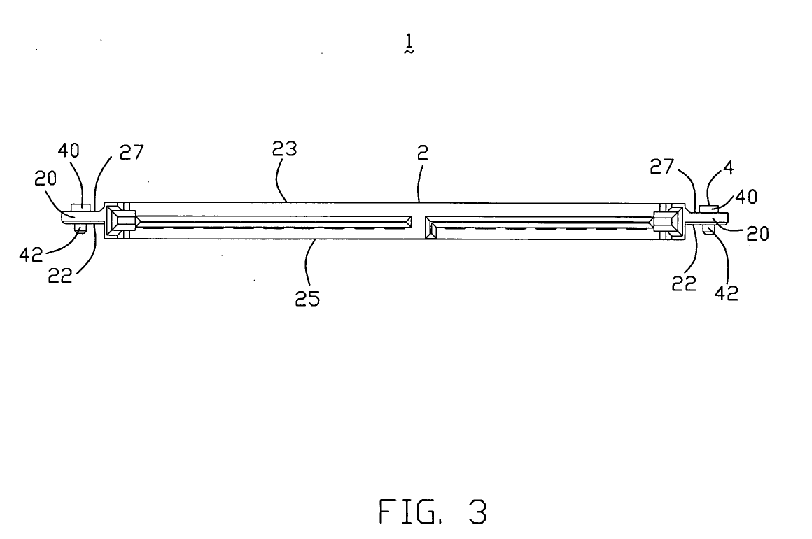

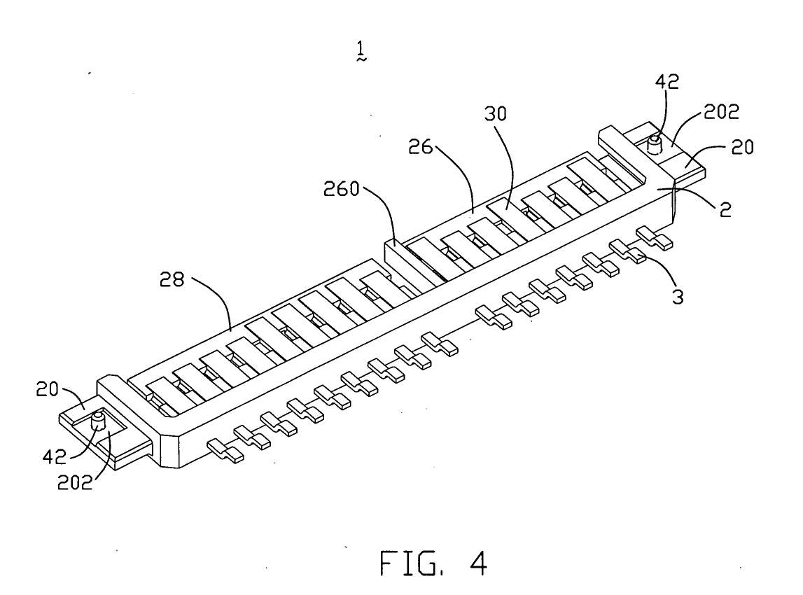

The dielectric housing 2 comprises a top surface 23, an opposite bottom surface 25 (specially referring to FIG. 3), a pair of arms 24 between the top surface 23 and bottom surface 25. A mating portion (not labeled) for engaging with a complementary electrical connector (not shown) is defined between the pair of arms 24. A pair of tongue boards 26, 28 extend between and spaced from said pair of arms 24. One of the pair of tongue boards 26, 28 comprises a projection 260 extending forward on a side of the tongue board 26 and on the edge adjacent to the other tongue board 28. There is a guiding groove 240 extending forward in the inner side of each arm 24. The block 20 extents out from the outer side of each arm 24. Each block 20 comprises a planar mounting surface 22 parallel to said top surface 23 for mounting on the printed circuit board (not shown), an opposite upper surface 27, and a through hole 200 perpendicular to the mounting surface 22 in the middle portion of the block 20. Specially referring to FIG. 3, there is a distance between the mounting surface 22 and the bottom surface 25, in other words, a portion of the dielectric housing 2 will sink in the printed circuit board (not shown), and so the total height of the electrical connector 1 will be lowered. Specially referring to FIG. 4, each block 20 defines a sunken recess 202 in the mounting surface 22 and communicating said through hole 200; this structure makes the mounting surface 22 easy to accurately engage the printed circuit board (not shown).

The plurality of conductive contacts 3 are respectively secured in said dielectric housing 2. As shown in FIG. 4, each conductive contact 3 comprises a contacting section 30 (specially referring to FIG. 4) extending to the tongue board 26, 28 on the same side where the projection 260 extending on for electrically contacting with the complementary electrical connector (not shown).

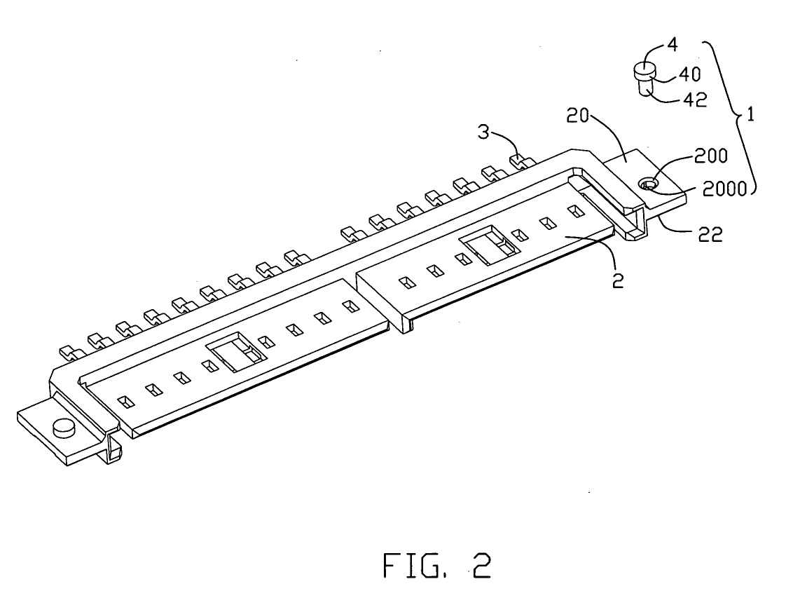

The pair of metal posts 4 are respectively inserted through the pair of blocks 20 retained in the through hole 200, each metal post 4 comprises a connecting section 42 stick out the mounting surface 22 of the block 20 for soldering on the printed circuit board (not shown), and a stop section 40 hold on the upper surface 27 of the block 20 preventing the dielectric housing 2 from moving. Specially referring to FIG. 2, each through hole 200 comprises some ribs 2000 therein, each metal post 4 interferes with the ribs 2000 in the through hole 200, so the block 20 is not easy to crack when inserting the metal post 4, and allow a bigger fit tolerance between the through hole 200 and the metal post 4.

In the electrical connector 1 in accordance with the present invention, the blocks 20 are made into a thin board, and the stop section 40 of the metal post 4 is made into a thin cap. The total height of the block 20 and metal post 4, from the mounting surface 22, is very low to meet the demand of smaller and thinner equipment.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector comprising:
an elongate dielectric housing comprising a pair of blocks on opposite elongate sides, and a mating portion between said pair of blocks, each said block comprising a planar mounting surface, an opposite upper surface, and a through hole perpendicular to said mounting surface;
a plurality of conductive contacts respectively secured in said dielectric housing, a section of each conductive contact extending to said mating portion for contacting with a complementary electrical connector;
a pair of metal posts respectively inserted into said through holes in said pair of blocks, each metal post comprising a connecting section stick out said mounting surface of said block, and a stop section hold on the upper surface of said block.

2. The electrical connector as described in claim 1, wherein said dielectric housing defines a top surface parallel to said mounting surface and a opposite bottom surface, said mounting surface and upper surface of each said block are located between said top surface and bottom surface.

3. The electrical connector as described in claim 2, wherein each said through hole comprises some ribs therein, each said metal post interferes with said ribs.

4. The electrical connector as described in claim 3, wherein each said block defines sunken recess in said mounting surface and communicating said through hole.

5. The electrical connector as described in claim 4, wherein said dielectric housing further comprises a pair of arms, and a pair of tongue boards between and spaced from said pair of arms, there is a guiding groove extending forward in the inner side of each arm, and each said block respectively extents sidewards from the outer side of each arm.

6. The electrical connector as described in claim 5, wherein one said tongue board comprises a projection extending forward on a side of the tongue board and on the edge adjacent to the other tongue board, while a section of each said plurality conductive contacts extend on the same side of each said tongue board which said projection extending on.

7. An electrical connector adapted for engaging with a complementary electrical connector and mounting on a printed circuit board, comprising:
an elongate dielectric housing comprising a top surface, an opposite bottom surface, a pair of blocks on opposite elongate sides and between said top surface and bottom surface, and a mating portion defined between said blocks, each said block comprising a planar mounting surface parallel to said top surface for mounting on the printed circuit board and an opposite upper surface;
a plurality of conductive contacts respectively secured in said dielectric housing, each conductive contact comprising a contacting section extending to said mating portion for electrically contacting with said complementary electrical connector;
a pair of metal posts respectively secured in said pair of blocks, each metal post comprising a connecting section stick out said mounting surface of said block for soldering on said printed circuit board, and a stop section hold on the upper surface of said block preventing said dielectric housing from moving.

8. The electrical connector as described in claim 7, wherein each said block comprises a through hole in the middle portion, each said through hole comprises some ribs therein, each said metal post interferes with said ribs.

9. The electrical connector as described in claim 8, wherein each block defines sunken recess in said mounting surface and communicating said through hole.

10. The electrical connector as described in claim 9, wherein said dielectric housing further comprises a pair of arms, and a pair of tongue boards between said pair of arms, there is a guiding groove extending forward in the inner side of each arm, and each said block respectively extents out from the outer side of each arm.

11. The electrical connector as described in claim 10, wherein one said tongue board comprises a projection extending forward on a side of the tongue board and on the edge adjacent to the other tongue board, while said plurality conductive contacts extend to each said tongue board on the same side which said projection extending on.

12. An electrical connector comprising:
an elongated insulative housing defining opposite upper and bottom faces;
a pair of mounting ears located at opposite ends of the housing, respectively, each
of said mounting ears being located between said upper and bottom faces;
a through hole extending through each corresponding mounting ear;
a metallic post downwardly extending through the corresponding through hole with at a top end thereof a locking head seated upon an upper surface of the mounting ear; where
a bottom surface of the mounting ear defines an upwardly recessed step in a middle portion wherein said through hole is located.

13. The assembly as claimed in claim 12, wherein said post extends the corresponding through hole in an interference fit.
